(19) United States
(12) Patent Application Publication
(10) Pub. No.: US 2019/0389343 A1
(43) Pub. Date: Dec. 26, 2019

(54) AIR SYSTEM FOR A SEAT

(71) Applicant: KA Group AG, Zurich (CH)

(72) Inventors: Ian Fletcher, Highland Twp., MI (US); Douglas Wheeler, Farmington Hills, MI (US)

(21) Appl. No.: 16/014,395

(22) Filed: Jun. 21, 2018

(51) Int. Cl. B60N 2/52; B60N 2/22

(52) U.S. Cl. CPC B60N 2/525; B60N 2/22

(57) ABSTRACT

An air system for a seat includes an air pump, a first air operated task unit, and a second air operated task unit. The air pump is adapted to output a system air volume at a constant flow rate. The first air operated task unit is adapted to receive at least a portion of the system air volume and operate at a first pressure. The second air operated task unit is adapted to receive at least a portion of the system air volume and operate at a second pressure different than the first pressure.

### INTRODUCTION

The present disclosure relates to an air system for a seat, and more particularly, to the air system having multiple air operated task units operating at different pressures with a single air pump of the air system.

Seats, such as those found in vehicles, include a wide range of operating features. The features may include the ability to move the seat in vertical and horizontal directions, adjustably tilting a back portion of the seat, adjusting a head rest, adjusting a lumbar support, operating a massage unit, adjusting various bolsters, and other features. Many of these features may be operated utilizing pressurized air. Unfortunately, various features may operate at different air pressures, necessitating the use of multiple, or dedicated, air pumps, and/or complicated circuitry and valve arrangements to achieve the unique air pressures and flow rates for each feature. Moreover, when various features are operated in unison, additional complication may arise.

It is desirable to simplify, reduce cost, and/or enhance robustness and durability of air systems used to support various features of seats.

### SUMMARY

In one exemplary embodiment, an air system for a seat includes an air pump, a first air operated task unit, and a second air operated task unit. The air pump is adapted to output a system air volume at a constant flow rate. The first air operated task unit is adapted to receive, at least a portion of, the system air volume and operate at a first pressure. The second air operated task unit is adapted to receive, at least a portion of, the system air volume and operate at a second pressure different than the first pressure.

In addition to one or more of the features described herein, the first and second air operated task units each include an isolation valve in fluid communication with the air pump.

In addition to one or more of the features described herein, the first and second air operated task units each include a pressure relief device in fluid communication with and downstream of the respective isolation valves.

In addition to one or more of the features described herein, the pressure relief device of the first air operated task unit is configured to operate at the first pressure, and the pressure relief device of the second air operated task unit is configured to operate at the second pressure.

In addition to one or more of the features described herein, the pressure relief device of the first air operated task unit is adapted to expel at least a portion of the system air volume when the first pressure is exceeded, and the pressure relief device of the second air operated task unit is adapted to expel at least a portion of the system air volume when the second pressure is exceeded.

In addition to one or more of the features described herein, the first air operated task unit includes a massage system adapted to operate at the first pressure, and the second operated task unit includes a lumbar support system adapted to operate at the second pressure.

In addition to one or more of the features described herein, the first and second air operated task units each include inflatable air cell assemblies respectively adapted to operate at the first and second pressures.

In addition to one or more of the features described herein, the first and second air operated task units each include inflatable air cell assemblies in fluid communication with and located downstream of the respective pressure relief devices.

In another exemplary embodiment, an air system for a vehicle seat includes a first inflatable air cell assembly, a second inflatable air cell assembly, an air pump, a first valve, a second valve, a first pressure relief device, and a second pressure relief device. The air pump is adapted to output a system air volume of pressurized air. The first valve is adapted to selectably flow a first air volume of the system air volume from the air pump. The second valve is adapted to selectably flow a second air volume of the system air volume from the air pump. The first pressure relief device is configured to relieve a portion of the first air volume, and flow a remaining portion of the first air volume to the first inflatable air cell assembly if a system air pressure of the system air volume exceeds a first maximum pressure value. The second pressure relief device is configured to relieve a portion of the second air volume, and flow a remaining portion of the second air volume to the second inflatable air cell assembly if the system air pressure exceeds a second maximum pressure value. The second maximum pressure value is different than the first maximum pressure value.

In addition to one or more of the features described herein, the system air pressure is equal to or greater than the first maximum pressure value, and the first maximum pressure value is greater than the second maximum pressure value.

In addition to one or more of the features described herein, the air pump is a diaphragm pump.

In addition to one or more of the features described herein, the air pump is configured to run continuously when at least one of the first and second valves are open.

In addition to one or more of the features described herein, the first and second valves are solenoid valves.

In addition to one or more of the features described herein, the air system includes a pressure regulator adapted to receive the system air volume from the air pump and expel the system air volume to the first and second valves.

In addition to one or more of the features described herein, the first inflatable air cell assembly is a massage system including a plurality of air cells.

In addition to one or more of the features described herein, the second inflatable air cell assembly is an adjustable lumbar support system including at least one air cell.

In addition to one or more of the features described herein, the first and second pressure relief devices each include a plunger, a spring, and a body, the body defining an inlet port in fluid communication with the respective first and second valves, an outlet port in fluid communication with the respective first and second inflatable air cell assemblies, and a relief port in fluid communication with atmosphere, wherein the spring is adapted to bias the plunger over the relief port.

In addition to one or more of the features described herein, the spring of the first pressure relief device includes a spring constant associated with the first maximum pressure value and the spring of the second pressure relief device includes a spring constant associated with the second maximum pressure value.

In addition to one or more of the features described herein, the bodies of the first and second pressure relief devices are identical.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description of embodiments, the detailed description referring to the drawings in which:

FIG. 1 is a schematic of a seat utilizing an air system as one exemplary, non-limiting, embodiment of the present disclosure;

FIG. 2 is a perspective view of a valve block of the air system;

FIG. 3 is a cross section of the valve block; and

FIG. 4 is a schematic of the air system having inflatable air cell assemblies.

### DETAILED DESCRIPTION

The following description is merely exemplary in nature and is not intended to limit the present disclosure, its application or uses. It should be understood that throughout the drawings, corresponding reference numerals indicate like or corresponding parts and features.

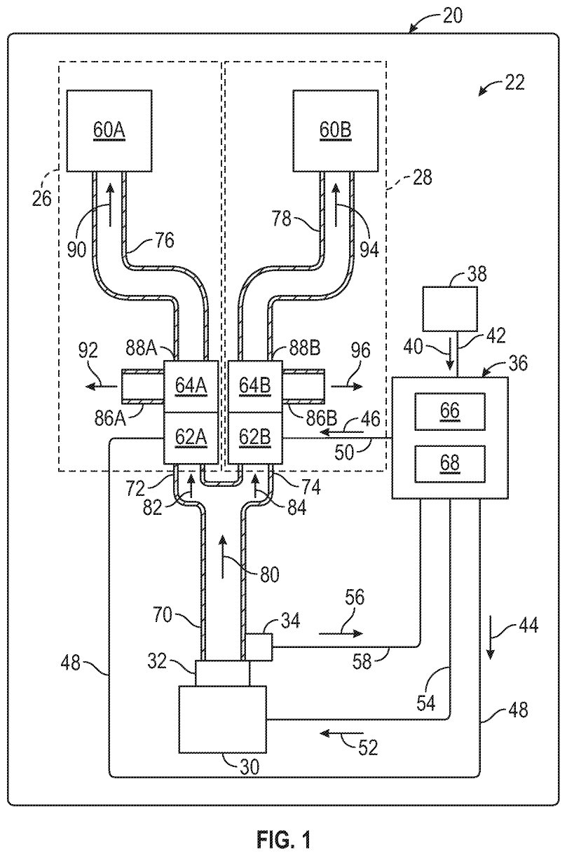

Referring now to the drawings, and in accordance with an exemplary embodiment, FIG. 1 illustrates a seat 20 including an air system 22. In one, non-limiting, example, the seat 20 may be a vehicle seat. The air system 22 may include a plurality of air operated task units (i.e., two illustrated as 26, 28), an air pump 30, a pressure regulator 32, a sensor 34 (e.g., pressure sensor), a controller 36, and a human-machine interaction component (HMI) 38. The HMI 38 may be configured to send command signals (see arrow 40) to the controller 36 over a pathway 42. The controller 36 is configured to send actuation signals (see arrows 44, 46) over respective pathways 48, 50, and to the respective air operated task units 26, 28. The controller 36 may be further configured to send an energize signal (see arrow 52) to the air pump 30, and via pathway 54. The sensor 34 may be configured to send a data signal (see arrow 56) over pathway 58, and to the controller 36 for processing. Any one or more of the pathways 42, 48, 50, 54, 58 may be hardwired or wireless. It is contemplated and understood that the seat 20 may be a plurality of seats (i.e., seat arrangement), and/or may generally be a piece of furniture associated with a dwelling. It is further understood that the air system 22 may be applied to other applications such as beds, recliners, desk chairs, and/or other relaxation components.

The air operated task units 26, 28 may each include respective air actuator assemblies 60A, 60B, respective valves 62A, 62B (e.g., electric solenoid, isolation, valves), and respective pressure relief devices 64A, 64B. In one embodiment, the air operated task units 26, 28 may generally operate at different pressures that may be maximum pressures, and may require different air volumetric flow rates. One or more of the air actuator assemblies 60A, 60B may be an inflatable air cell assembly, a hydraulic actuator, or any other device actuated by air.

In the example of one or more of the air actuator assemblies 60A, 60B being an inflatable air cell assembly, the task unit 26 may be, or may be part of, a massage system integrated into the seat 20, and/or the task unit 28 may be, or may be part of, an adjustable lumbar support system that may operate at a lower maximum pressure than the massage system. Other examples, or applications, of the air operated task units 26, 28, which may or may not include the example of inflatable air cell assemblies, may include a system for moving the position of a seat base of the seat 20 within a vehicle (i.e., up, down, forward, and/or rearward), a system for adjusting and/or positioning a head rest, a system for adjusting bolsters on a back and/or the base of the seat 20, a system for adjusting a leading edge of the seat base, and others.

The controller 36 may include a processor 66 (e.g., microprocessor) and an electronic storage medium 68 (e.g., non-transitory medium) that may be computer writeable and readable. The HMI 38 may be at least one mechanical switch or may be part of a touch screen display. In one embodiment, the controller 36 and/or the HMI 38 may be an integral part of the switch (i.e., supported by a seat structure, not shown). In another embodiment, the controller 36 and/or the HMI 38 may be remotely located from the seat 20. For example, the HMI 38 may be mounted to a console of a vehicle.

In one embodiment of the air system 22, the controller 36 may be configured to identify a specific driver. With the driver identified, the processor 66 may access previous seat adjustments stored in the storage medium 68 (i.e., preprogrammed). Once the previous seat adjustments are retrieved, the processor 66 may automatically initiate the necessary adjustments via outputting the signals 44, 46, 48, 52 to re-establish the previous seat adjustments. In this example, the air system 22 may include a multitude of sensors (e.g., position sensors) configured to inform the processor 66 of current seat positions. In another, more simplified, embodiment of the air system 22, the system may not include a computer-based processor. Instead, the HMI 38 may be, or may include, at least one multipole switch constructed to energize the air pump 30 and a selected one, or all, of the solenoid valves 62A, 62B. It is contemplated and understood that the degree of complexity of the air system 22 may be dependent upon the type of task units involved.

The air system 20 may include various conduits 70, 72, 74, 76, 78. The conduit 70 is in fluid communication between the air pump 30 and both of the conduits 72, 74 for the flow of a total, or main, air volume (see arrow 80) from the air pump 30 to the conduits 72, 74. The conduit 72 may be in fluid communication between the conduit 70 and the valve 62A of the task unit 26 for the selective flow of a first air volume (see arrow 82) of the main air volume 80. The conduit 74 is in fluid communication between the conduit 70 and the valve 62B of the task unit 28 for the selective flow of a second air volume (see arrow 84) of the main air volume 80. In operation, and if both of the valves 62A, 62B are open, the flow rates of the first and second air volumes 82, 84 (i.e., or the air volumes 82, 84 in an instance in time) may be different, and may have substantially the same pressure. If, for example, the valve 62A is closed and the valve 62B is open, the first air volume 82 may not exist, and the second air volume 84 may be substantially equal to the main air volume 80 (i.e., flow rate), and vice-versa. It is contemplated and understood that the term “conduit” may be a passage or channel defined by a structure, or may be a structure such as a tube that defines a passage for the flow of air. It is understood that the term “air volume” may generally be interchanged with the term “air volumetric flow rate.”

In one embodiment, the pressure regulator 32 may be located at an outlet of the air pump 30, and/or may interpose the conduit 70. The pressure regulator 32 is adapted to control the air pressure of the main air volume 80 within the conduits 70, 72, 74. The pressure sensor 34 is configured to send the signal 56, indicative of the air pressure of the air volumes 80, 82, 84 to the controller 36 for the control of the air pump 30. The pressure sensor 34 may be an integral part of the pressure regulator 32, or may be located downstream of the pressure regulator. In one example, the air pump 30 may be a diaphragm pump such as a rolling diaphragm pump.

The pressure relief device 64A is located downstream of, and is in fluid communication with, the valve 62A of the task unit 26. The pressure relief device 64B is located downstream of, and is in fluid communication with, the valve 62B of the task unit 28. Each pressure relief device 64A, 64B includes respective relief outlets 86A, 86B that may be vented to atmosphere, and respective air supply outlets 88A, 88B. The pressure relief device 64A is constructed to assure a first maximum air pressure value of a portion (see arrow 90) of the air volume 82 flowing through the air supply outlet 88A is not exceeded by relieving air pressure via the release of a portion (see arrow 92) of the air volume 82 through the relief outlet 86A. Similarly, the pressure relief device 64B is adapted to assure a second maximum air pressure value of a portion (see arrow 94) of the air volume 84 flowing through the air supply outlet 88B is not exceeded by relieving air pressure via the release of a portion (see arrow 96) of the air volume 84 through the relief outlet 86B. The first and second maximum air pressure values may generally be dictated by the needs and/or design criteria of the respective air actuator assemblies 60A, 60B, and may not be equal. If the air pressure of the air volume 82 (i.e., or main air volume 80) does not exceed the first maximum air pressure value, the air volume portion 90 may be about equal to the air volume 82. Similarly, if the air pressure of the air volume 84 (i.e., or main air volume 80) does not exceed the second maximum air pressure value, the air volume portion 94 may be about equal to the air volume 84.

The conduit 76 may be in fluid communication between the air supply outlet 88A of the pressure relief device 64A and the air actuator assembly 60A for the flow of the portion 90 of the air volume 82 to the air actuator assembly 60A. Similarly, the conduit 78 may be in fluid communication between the air supply outlet 88B of the pressure relief device 64B and the air actuator assembly 60B for the flow of the portion 94 of the air volume 84 to the air actuator assembly 60B.

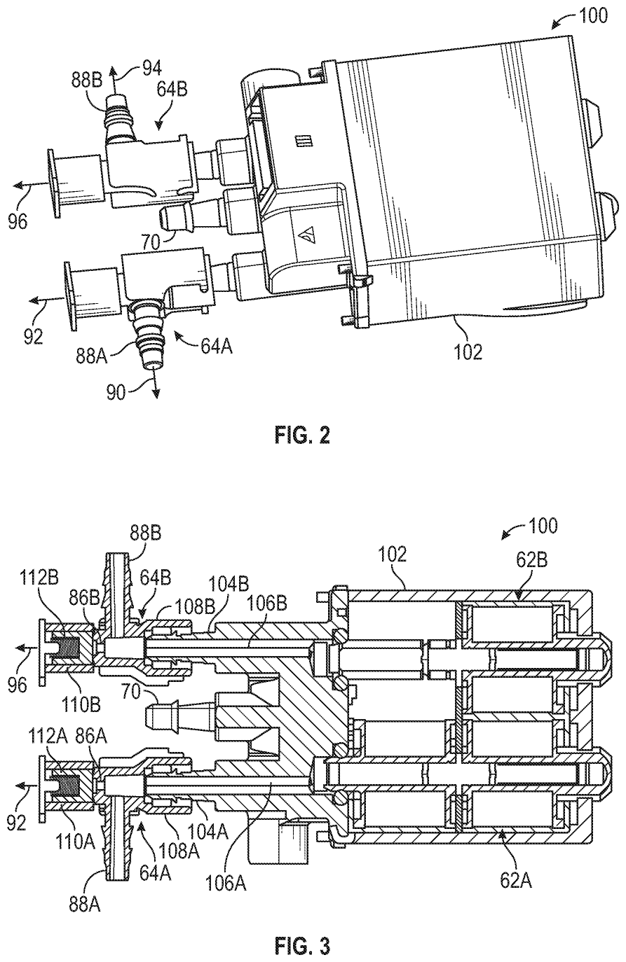

Referring to FIGS. 2 and 3, the air system 20 may further include a valve block 100. The valve block 100 may include a body 102, the solenoid valves 62A, 62B (e.g., isolation or shut-off valves, see FIG. 3), and the pressure relief devices 64B, 64B. The valves 62A, 62B may be an integral part of, and supported by, the body 102. Similarly, the body 102 may be part of, and/or may include internal boundaries that define the conduits 72, 74 (not shown). In one example, the body 102 may include barbed nipples 104A, 104B for a snap fit attachment of the respective pressure relief devices 64A, 64B. Each nipple 104A, 104B may include internal boundaries that define respective channels 106A, 106B for the flow of respective air volumes 82, 84 from the valves 62A, 62B to the respective pressure relief devices 64A, 64B. It is contemplated and understood that the valve block 100 may include a multitude of shutoff valves and a multitude of pressure relief devices each having an associated and unique maximum pressure relief value, with the multitude of valves and pressure relief devices equal to a multitude of air actuator assemblies all operated via a single air pump.

Referring to FIG. 3, the pressure relief devices 64A, 64B may include respective bodies 108A, 108B, plungers 110A, 110B, and springs 112A, 112B (e.g., coiled springs). The bodies 108A, 108B each include internal boundaries that define the respective outlets 86A, 88A, 86B, 88B. The plungers 110A, 110B are movably supported by the respective bodies 108A, 108B, and are biased against the bodies to close-off the respective pressure relief outlets 86A, 86B by forces exerted by the respective springs 112A, 112B. In one embodiment, the springs 112A, 112B may each include different spring constants thus exerting different forces against the respective plunger. Each spring constant is associated with the respective maximum pressure relief value. In this example, the bodies 108A, 108B may be identical. In another example, the flow cross sectional area of each outlet 86A, 86B may be different and indicative of the desired maximum pressure relief values.

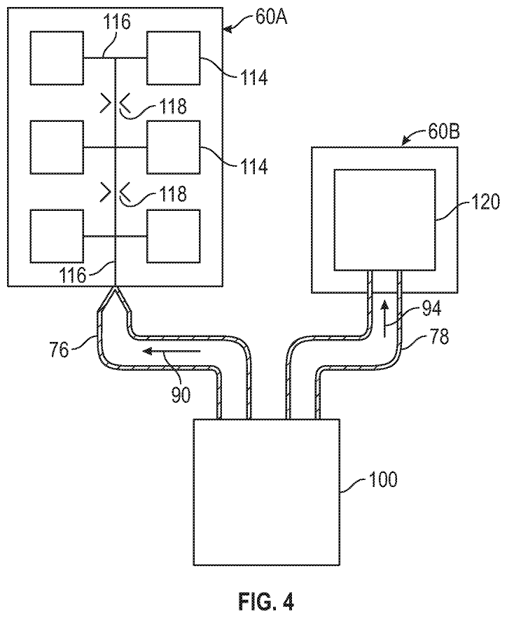

Referring to FIG. 4, and as previously described, the air actuator assemblies 60A, 60B may be inflatable air cell assemblies. More specifically, the inflatable air cell assembly 60A may be, or may be part of, a massage system, and the air cell assembly 60B may be an adjustable lumbar support system. In this example, the massage system 60A may include a plurality of air cells 114, a conduit network 116, conduit restrictors 118, and other components. In operation, the conduit network 116 combined with the restrictor 118 is adapted to supply varying air volume flow rates to the various air cells 114 to inflate and deflate the air cells at different times, and as known in the art of massage systems (see U.S. Patent Publication No. 2016/0213553, titled: Massage System for a Vehicle Seat, assigned to Kongsberg Automotive, with a publication date of: Jul. 28, 2016, and incorporated herein by reference in its entirety).

In contrast to the massage system 60A, the adjustable lumbar support system (i.e., as an example of the air actuator assembly 60B) may include a single air cell 120. The adjustable lumbar support system 60B may thus require an air volume portion 94 at a lower maximum operating pressure than the air volume portion 90 used by the massage system 60A.

In one embodiment, for simplicity of design, and referring back to FIG. 1, the air pump 30 may be configured to run continuously, and at a constant volumetric flow rate, when one or both of the task units 26, 28 are running and the associated valves 62A, 62B are thus open. The air pump 30 may thus be sized to provide all of the air volume needs of all of the task units 26, 28 when running in unison. Each pressure relief device 64A, 64B of the respective task units 60A, 60B is sized to enable the removal of excess air via the respective pressure relief ports 86A, 86B when the other task unit is not running (i.e., the associated valve of the non-running task unit is closed).

In operation of the air system 20, a user may initiate one, or both (i.e., in unison or consecutively), of the task units 26, 28, via the HMI 38. For example, the user may desire adjustment of the lumbar support system 60B of the task unit 28, and enters this desire into the HMI 38. The HMI 38 then sends an appropriate command signal 40 to the controller 36. The controller 36 may process the command signal 40 and outputs an associated energization signal 52 to the air pump 30 that effectuates running of the pump, and an appropriate actuation signal 46 to the valve 62B that effectuates opening of the valve. With the air pump 30 running, the valve 62A of the task unit 26 closed, and the valve 62B of the task unit 28 open, all of the air volume 80 flows through the valve 62B and to the pressure relief device 64B.

Since the air pump 30 may be a constant volumetric flow rate pump, and without the massage system 60A running (i.e., the valve 62A closed), the pressure relief device 64B of the task unit 28 associated with the lumbar support system 60B receives all of the main air volume 80 (i.e., volume 80 equals volume 84). The operating air pressure will increase, and with the other valve 62A closed, will likely exceed the maximum operating pressure value of the pressure relief device 64B. Once exceeded, the force exerted by the spring 112B (see FIG. 3) is overcome by the force exerted against the plunger 110B due to internal air pressure, the plunger lifts away from the opening 86B and a portion 96 of the air volume 80 is expelled to atmosphere, while a required portion 94 flows to the lumbar support system for operation. In one example, the maximum air pressure value associated with the massage system 60A may be about 500 mbar, and the maximum air pressure value for the lumbar support system 60B may be about 300 mbar.

In another system operation scenario, the user may generally initiate both task units 26, 28 in unison via the HMI 38. The HMI 38 may then send appropriate command signals 40 to the controller 36. The controller 36 may process the command signals 40 and outputs the energization signal 52 to the air pump to, and sends actuation signals 44, 46 to the respective valves 62A, 62B of the respective task units 26, 28. With both valves 62A, 62B open, the main air volume 80, or main volumetric flow of air, may generally be split between the task units 26, 28 (i.e., respective volumes 82, 84). Depending upon the various flow demands between the running task units 26, 28 in any instance in time, the respective pressure relief devices 64A, 64B will relieve pressure and thus expel a respective portion 92, 96 of the respective air volumes 82, 84 to protect the respective actuator assemblies 60A, 60B. In another embodiment, and with all of the task units 26, 28 running, the air pump 30 may be sized such that the needed volumetric flow rate is large enough where the smallest of the maximum pressure relief values is not exceeded, thus no volume of air need be expelled to atmosphere.

In yet another operation scenario and dependent upon the type of task unit served, the air actuator assembly 60B may be in a dead-headed state and contains the needed portion 94 of the air volume 84 in any instance in time. With the air actuator assembly 60B in this state, the valve 62B may be open, the valve 62A may be closed, and the air pump 30 may be running outputting the main air volume 80 at a constant flow rate. In this scenario, the volumetric flow of air entering the air actuator assembly 60B is minimal as long as the air pressure of the portion 94 of the air volume 84 is maintained at the maximum air pressure value controlled by the pressure relief device 64B. When controlled at the maximum air pressure value, the rate of flow of the expelled portion 96 of air volume 84 (or air volume 80 since the other valve 62A is closed) is about equal to the flow rate of the main air volume 80.

Similar operating principles will apply if both valves 62A, 62B are open and both air actuator assemblies 60A, 60B are operational and in a dead-headed state. That is, the flow rate of the expelled portion 92 of the air volume 82 is substantially equal to the flow rate of the air volume 82, and the flow rate of the expelled portion 96 of the air volume 84 is substantially equal to the flow rate of the air volume 84. The flow rates of the expelled portions 92, 94, combined, is substantially equal to the constant flow rate of the main air volume 80 produced by the air pump 30.

Advantages and benefits of the present disclosure include an air system 20 having a single air pump 30 capable of supply air to multiple task units each operating at different, air pressure values. Other advantages include a relatively inexpensive air pump operating at a constant speed and producing a constant volumetric flow rate of air. Further advantages include an air system requiring minimal electronics contributing toward reduced cost, simplicity, and a robust design.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof

What is claimed is:

1. An air system for a seat comprising;
an air pump adapted to output a system air volume at a constant flow rate;
a first air operated task unit adapted to receive at least a portion of the system air volume and operate at a first pressure; and
a second air operated task unit adapted to receive at least a portion of the system air volume and operate at a second pressure different than the first pressure.

2. The air system set forth in claim 1, wherein the first and second air operated task units each include an isolation valve in fluid communication with the air pump.

3. The air system set forth in claim 2, wherein the first and second air operated task units each include a pressure relief device in fluid communication with and downstream of the respective isolation valves.

4. The air system set forth in claim 3, wherein the pressure relief device of the first air operated task unit is configured to operate at the first pressure, and the pressure relief device of the second air operated task unit is configured to operate at the second pressure.

5. The air system set forth in claim 4, wherein the pressure relief device of the first air operated task unit is adapted to expel at least a portion of the system air volume when the first pressure is exceeded, and the pressure relief device of the second air operated task unit is adapted to expel at least a portion of the system air volume when the second pressure is exceeded.

6. The air system set forth in claim 1, wherein the first air operated task unit includes a massage system adapted to operate at the first pressure, and the second operated task unit includes a lumbar support system adapted to operate at the second pressure.

7. The air system set forth in claim 1, wherein the first and second air operated task units each include inflatable air cell assemblies respectively adapted to operate at the first and second pressures.

8. The air system set forth in claim 5, wherein the first and second air operated task units each include inflatable air cell assemblies in fluid communication with and located downstream of the respective pressure relief devices.

9. An air system for a vehicle seat comprising:
a first inflatable air cell assembly;
a second inflatable air cell assembly;
an air pump adapted to output a system air volume of pressurized air;
a first valve adapted to selectably flow a first air volume of the system air volume from the air pump;
a second valve adapted to selectably flow a second air volume of the system air volume from the air pump;
a first pressure relief device configured to relieve a portion of the first air volume and flow a remaining portion of the first air volume to the first inflatable air cell assembly if a system air pressure of the system air volume exceeds a first maximum pressure value; and
a second pressure relief device configured to relieve a portion of the second air volume and flow a remaining portion of the second air volume to the second inflatable air cell assembly if the system air pressure exceeds a second maximum pressure value, wherein the second maximum pressure value is different than the first maximum pressure value.

10. The air system set forth in claim 9, wherein the system air pressure is equal to or greater than the first maximum pressure value, and the first maximum pressure value is greater than the second maximum pressure value.

11. The air system set forth in claim 9, wherein the air pump is a diaphragm pump.

12. The air system set forth in claim 9, wherein the air pump is configured to run continuously when at least one of the first and second valves are open.

13. The air system set forth in claim 9, wherein the first and second valves are solenoid valves.

14. The air system set forth in claim 9, further comprising:
a pressure regulator adapted to receive the system air volume from the air pump and expel the system air volume to the first and second valves.

15. The air system set forth in claim 9, wherein the first inflatable air cell assembly is a massage system including a plurality of air cells.

16. The air system set forth in claim 15, wherein the second inflatable air cell assembly is an adjustable lumbar support system including at least one air cell.

17. The air system set forth in claim 9, wherein the first and second pressure relief devices each include a plunger, a spring, and a body, the body defining an inlet port in fluid communication with the respective first and second valves, an outlet port in fluid communication with the respective first and second inflatable air cell assemblies, and a relief port in fluid communication with atmosphere, wherein the spring is adapted to bias the plunger over the relief port.

18. The air system set forth in claim 17, wherein the spring of the first pressure relief device includes a spring constant associated with the first maximum pressure value and the spring of the second pressure relief device includes a spring constant associated with the second maximum pressure value.

19. The air system set forth in claim 18, wherein the bodies of the first and second pressure relief devices are identical.
